(19) United States
(12) Patent Application Publication
(10) Pub. No.: US 2013/0095875 A1
(43) Pub. Date: Apr. 18, 2013

(54) ANTENNA SELECTION BASED ON ORIENTATION, AND RELATED APPARATUSES, ANTENNA UNITS, METHODS, AND DISTRIBUTED ANTENNA SYSTEMS

(71) Applicant: RAMI REUVEN, RISHON LETZION (IL)

(72) Inventor: RAMI REUVEN, RISHON LETZION (IL)

(21) Appl. No.: 13/628,467

(22) Filed: Sep. 27, 2012

Related U.S. Application Data
(60) Provisional application No. 61/541,566, filed on Sep. 30, 2011.

(51) Int. Cl. H04B 7/10; H01Q 21/24

(52) U.S. Cl. CPC H04B 7/10; H01Q 21/24
USPC 455/509; 343/876; 455/507

(57) ABSTRACT

Antenna apparatuses and related antenna units that include antenna selection based on orientation are disclosed. Related methods and distributed antenna systems are also disclosed. Antenna selection is provided between two or more antennas disposed in different polarization orientations according to orientation of the antenna unit in which the antennas are included. The antenna(s) oriented most closely to perpendicular to the ground in one embodiment may be selected for use in wireless communications with wireless client devices. In this manner, the antenna(s) employed in wireless communications is likely to be the closest in polarization to the polarization of wireless client device antennas. Otherwise, an unacceptable reduction in communications link quality with the wireless client devices may occur.

### PRIORITY CLAIM

The application claims the benefit of priority under 35 U.S.C. §119 of U.S. Provisional Application No. 61/541,566, filed on Sep. 30, 2011, the content of which is relied upon and incorporated herein by reference in its entirety.

### BACKGROUND

1. Field of the Disclosure

The technology of the disclosure relates to remote antenna or antenna arrays that may be used in distributed antenna systems that distribute communications signals over a communications medium to one or more remote antenna units for communicating with wireless client devices in range of the remote antenna units.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas (e.g., coffee shops, airports, libraries, etc.). Distributed communications or antenna systems communicate with wireless devices called “clients,” “client devices,” or “wireless client devices,” which must reside within the wireless range or “cell coverage area” in order to communicate with an access point device. Distributed antenna systems, or “DAS” systems are particularly useful to be deployed inside buildings or other indoor environments where client devices may not otherwise be able to effectively receive RF signals from a source, such as a base station.

One approach to deploying a DAS involves the use of radio frequency (RF) antenna coverage areas, also referred to as “antenna coverage areas.” Antenna coverage areas can be formed by remotely distributed antenna units, also referred to as remote antenna units (RAUs). The RAUs each contain or are configured to couple to antennas configured to support the desired frequency(ies) or polarization to provide the antenna coverage areas. Typical antenna coverage areas have a radius in the range from a few meters up to twenty meters. Combining a number of access point devices creates an array of antenna coverage areas. Because the antenna coverage areas each cover small areas, there typically may be only a few users (clients) per antenna coverage area. This arrangement can allow for minimizing the amount of RF bandwidth shared among the wireless system users.

Because the RAUs in a DAS may be configured to support higher frequency RF signals which are more easily attenuated, RAUs may heavily rely on line-of-sight communications for successful communications with client devices. The polarization of the antenna will determine the direction of RF signal propagation by the antenna of a RAU. The polarization of an antenna is defined as the orientation of the electric field (E-field) of the RF signals transmitted by the antenna with respect to a reference antenna. For example, if the reference antenna is a wireless client device that is normally arranged such that the wireless client antenna is perpendicular to the Earth's surface, the polarization of the antenna may be the orientation of the E-field of the RF signals transmitted by the antenna with respect to a reference such as the Earth's surface. The polarization of the antenna is determined by its physical structure and orientation. For line-of-sight communications, the antenna of the RAU should ideally be oriented in the same expected orientation of the antenna of the client device. Otherwise, communications link quality between the RAU and the client device may be reduced. However, RAUs are typically configured to be mounted in different orientations depending on the infrastructure of the building where the DAS is employed. For example, it may be desired or necessary to mount a RAU on the wall in certain locations in a building, and in the ceiling in other locations. These variations in RAU mounting locations change the polarization of the RAU antenna, many times unknown to the installing technician, thereby reducing communications link quality between RAUs and client devices.

### SUMMARY OF THE DETAILED DESCRIPTION

Embodiments disclosed herein include antenna apparatuses and related antenna units that include antenna selection based on orientation. Related methods and distributed antenna systems are also disclosed. Antenna selection is provided between two or more antennas disposed in different polarization orientations according to the orientation of the apparatus or antenna unit in which the antennas are included. The polarization of an antenna is defined as the orientation of the electric field (E-field) of radio frequency (RF) waves emitted by the antenna with respect to a reference antenna of a wireless client device. For example, it may be typical for a wireless client device antenna to be oriented perpendicular referring to the Earth (also referred to herein as “the ground”) to provide a vertical polarization with respect to the ground. Thus, in certain embodiments disclosed herein, the antenna(s) most closely oriented perpendicular to the ground is automatically selected for use in wireless communications with wireless client devices. In this manner, the antenna(s) employed in wireless communications is likely to be the closest in polarization to the polarization of the antennas of the wireless client devices. Otherwise, an unacceptable reduction in communications link quality with the wireless client devices may occur. The selection of antennas can avoid the need for a technician to manually determine antenna installation orientation and manually configure antenna selection.

In this regard, in one embodiment, an antenna arrangement for distributing communications signals in a DAS comprises a first antenna arranged to have a first polarization orientation. The antenna arrangement also comprises a second antenna arranged to have a second polarization orientation different from the first polarization orientation of the first antenna. The antenna arrangement also comprises an orientation sensor configured to sense orientation with respect to the ground and provide an at least one orientation signal indicative of the sensed orientation. The antenna arrangement also comprises an antenna selection device configured to receive the at least one orientation signal and selectively couple one of the first antenna and the second antenna to a communications signal distributor for receiving and emitting communications signals to a wireless client device.

In one example, the first and second antennas may be provided in an antenna arrangement and/or remote antenna unit that are oriented perpendicular or substantially perpendicular to each other. The first antenna may be oriented perpendicular to the ground while the second antenna is oriented parallel to the ground, or vice versa. Thus, the polarizations of the first and second antennas are orthogonal to each other in any orientation. A selection device may be provided that is configured to select from among the first and second antennas the antenna that is oriented perpendicular to the ground or closest to perpendicular to the ground for use in communicating with wireless clients.

In another embodiment, a method for selection of an antenna for emitting communications signals comprises receiving communications signals from a communications signal distributor. The method also comprises receiving at least one orientation signal indicative of the sensed orientation from an orientation sensor configured to sense orientation with respect to the ground, selectively coupling one of a first antenna arranged to have a first polarization orientation and a second antenna arranged to have a second polarization orientation different from the first polarization orientation of the first antenna, to the communications signal distributor for receiving and emitting the communications signals.

In another embodiment, a remote antenna unit (RAU) for distributing communications signals in a DAS comprises a downlink communications signal distributor configured to receive downlink communications signals from a base station and distribute the received downlink communications signals to wireless client devices. The RAU also comprises at least one antenna arrangement. The at least one antenna arrangement comprises a first antenna arranged to have a first polarization orientation, a second antenna arranged to have a second polarization orientation different from the first polarization orientation of the first antenna, an orientation sensor configured to sense orientation with respect to the ground and provide an at least one orientation signal indicative of the sensed orientation, and an antenna selection device configured to receive the at least one orientation signal and selectively couple one of the first antenna and the second antenna to a downlink communications signal distributor for receiving and emitting the downlink communications signals received from the downlink communications signal distributor.

In another embodiment, a distributed antenna system comprises head end equipment configured to transmit downlink communications signals and receive uplink communications signals. The DAS also comprises at least one remote antenna unit (RAU) communicatively coupled to the head end equipment through at least one communications medium, and a downlink communications signal distributor configured to receive the downlink communications signals from the head end equipment and distribute the received downlink communications signals to wireless client devices. The at least one RAU also comprises at least one antenna arrangement having a first antenna arranged to have a first polarization orientation, a second antenna arranged to have a second polarization orientation different from the first polarization orientation of the first antenna, and an orientation sensor configured to sense orientation with respect to the ground and provide an at least one orientation signal indicative of the sensed orientation. The at least one antenna arrangement also comprises an antenna selection device configured to receive the at least one orientation signal and selectively couple one of the first antenna and the second antenna to a downlink communications signal distributor for receiving and emitting the downlink communications signals received from the downlink communications signal distributor.

As non-limiting examples, the antenna arrangements disclosed herein may be employed in remote antenna units in DAS systems that employ electrical conductors, wireless transmission means, and/or optical fiber as the communications media for distribution of communications signals. The antenna arrangements disclosed herein may be employed in RAUs and DAS systems that support both radio frequency (RF) communication services and digital data services. The RF communication services and digital data services can be distributed over optical fiber to wireless client devices, such as remote antenna units for example. Non-limiting examples of digital data services include WLAN, WiMax, WiFi, Digital Subscriber Line (DSL), WCDMA, and LTE. Digital data signals can be distributed over separate communications media for distributing RF communication services. Alternatively, digital data signals can be distributed over a common communications medium with RF communications signals.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary antenna arrangement employing antenna selection for use in communicating wireless signals to wireless client devices;

FIG. 2 is a schematic diagram of a remote antenna unit (RAU) employing an antenna selection arrangement configured to select an antenna having a polarization perpendicular to the ground or closest to perpendicular to the ground among a plurality of antennas, according to the orientation of the RAU;

FIG. 3 is a schematic diagram of a three-dimensional accelerometer that can be employed in a RAU to detect orientation of the RAU to control antenna selection;

FIG. 4 is a partially schematic cut-away diagram of a building infrastructure including a DAS with RAUs employing antenna selection;

FIG. 5 is a schematic diagram of an electrical conductor medium-based distributed antenna system that includes RAUs that include an antenna arrangement;

FIG. 6 is a schematic diagram of an optical fiber-based distributed antenna system that includes RAUs that include an antenna arrangement;

FIG. 7 is a schematic diagram of an alternative head-end equipment (HEE) configured to distribute radio frequency (RF) communication services over optical fiber to RAUs that include an antenna arrangement; and

FIG. 8 is a schematic diagram of a generalized representation of a computer system that can be included in any of the modules provided in the exemplary distributed antenna systems and/or their components described herein.

### DETAILED DESCRIPTION

Reference is now made in detail to the embodiments, examples of which are illustrated in the drawings. Whenever possible, like reference numbers are used to refer to like components or parts.

Embodiments disclosed herein include antenna apparatuses and related antenna units that include antenna selection based on orientation. Antenna selection is provided between two or more antennas disposed in different polarization orientations according to the orientation of the apparatus or antenna unit in which the antennas are included. The polarization of an antenna is defined as the orientation of the electric field (E-field) of radio frequency (RF) waves emitted by the antenna with respect to a reference antenna of a wireless client device. For example, it may be typical for a wireless client device antenna to be oriented perpendicular referring to the Earth (also referred to herein as “the ground”) to provide a vertical polarization with respect to ground. Thus, in certain embodiments disclosed herein, the antenna(s) most closely oriented perpendicular to the ground is automatically selected for use in wireless communications with wireless client devices. In this manner, the antenna(s) employed in wireless communications is likely to be the closest in polarization to the polarization of the antennas of the wireless client devices. Otherwise, an unacceptable reduction in communications link quality with the wireless client devices may occur. The selection of antennas can avoid the need for a technician to manually determine antenna installation orientation and manually configure antenna selection.

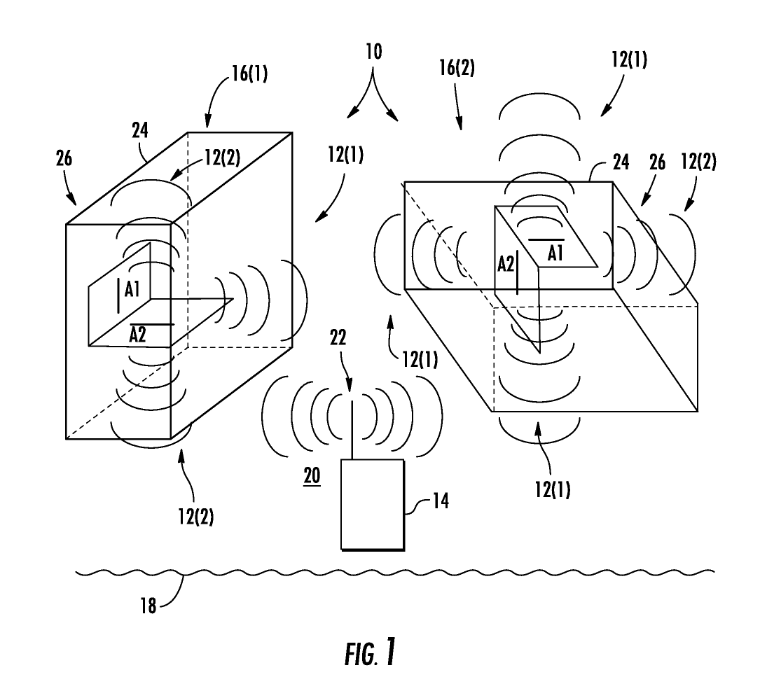

FIG. 1 is a schematic diagram of exemplary antenna arrangement 10. The antenna arrangement 10 employs antenna selection for use in communicating downlink and/or uplink wireless signals 12(1), 12(2) to a wireless client device 14. In this embodiment, the antenna arrangement 10 is shown in two different orientations 16(1), 16(2) to show how communications link efficiency can be optimized for communications with the wireless client device 14 for each orientation 16(1), 16(2). Orientation 16(1) is rotated approximately ninety (90) degrees from orientation 16(2) in this embodiment. For example, orientation 16(1) may be provided when the antenna arrangement 10 is wall mounted in a building and orientation 16(2) may be provided when the antenna arrangement 10 is ceiling mounted in a building. As illustrated in FIG. 1, in the first orientation 16(1), a first antenna Al is oriented in perpendicular plane with respect to ground 18. In this example, the first antenna Al is a patch antenna, but could be any antenna type, geometry, any number of poles, slot, and of one or more frequencies. This orientation of the first antenna A1 provides a vertical polarization orientation of the first antenna A1 with respect to the ground 18, as shown by the direction of communications signals 12(1). As also illustrated in FIG. 1, in the first orientation 16(1), a second antenna A2 is oriented in a parallel plane with respect to the ground 18. This orientation of the second antenna A2 provides a horizontal polarization orientation of the second antenna A2 with respect to the ground 18, as shown by the direction of communications signals 12(2). In this example, the second antenna A2 is also a patch antenna, but could be any antenna type or RF energy radiator, geometry, any number of poles, slot, and of one or more frequencies. Also note that either or both of the first and second antennas A1, A2 could be antenna arrays or included as part of antenna arrays.

Here, depending on the orientation 16(1), 16(2) of the antenna arrangement 10 in FIG. 1, either communication signals 12(1) from the first antenna A1, or communications signals 12(2) from the second antenna A2 will be provided in a vertical polarization orientation with respect to the ground 18. If an antenna 20 of the wireless client device 14 is oriented perpendicular to the ground 18, communication signals 22 emitted by the antenna 20 will be in a vertical polarization orientation with respect to the ground 18. Thus, for arrangement 16(1) of the antenna arrangement 10, the communications link quality will be improved by the presence and orientation of the first antenna A1 in the antenna arrangement. Communications link quality is improved when a transmitter and receiver (or transceiver) are oriented to have the same or substantially the same polarization orientation. If, however, the antenna arrangement 10 is oriented in orientation 16(2), the polarization orientation of the first antenna A1 would not be aligned with the polarization orientation of antenna 20. However, the communications link quality will be improved by the presence and orientation of the second antenna A2 in the antenna arrangement 10 because of the difference in orientation between the first antenna A1 and the second antenna A2 in the antenna arrangement 10.

Thus, as illustrated in FIG. 1, the antenna arrangement 10 is designed to be orientation independent if the antenna arrangement is rotated in ninety (90) degree increments from the orientation 16(1). In this embodiment, the antenna arrangement 10 is provided in a housing 24, together which may form a remote antenna unit RAU 26. As will be discussed below, the RAUs 26 have one or more communications signal distributor, which may be a transmitter, receiver, or transceiver, for distributing and receiving communications signals, including downlink and uplink communications signals. As will be discussed in more detail below, the RAU 26 may be included in a distributed antenna system for distributing downlink communications signals to wireless client devices and for receiving uplink communications signals from wireless client devices and distributing these signals back to a base station(s). Thus, in this embodiment, if a technician installs the RAU 26 in either the wall mounted orientation 16(1) or the ceiling mounted orientation 16(2), either the first antenna Al or the second antenna A2, respectively, will be oriented to have a polarization orientation perpendicular or substantially perpendicular to the ground 18.

A technician installing the RAU 26 may not properly select first antenna A1 or second antenna A2 to be active for wireless communications with the wireless client device 14 based on the orientation provided (e.g., 16(1) or 16(2)). If an installing technician does not properly select the correct antenna A1, A2 that has a vertical or substantially vertical polarization orientation to the ground 18 in the RAU 26 to be used for communications, the quality of the communications link to the wireless client device 14 will be reduced. For example, if an installing technician selects antenna A2 to be active and used for wireless communications by the RAU 26 in orientation 12(1) in FIG. 1, the polarization orientation of the second antenna A2 would be parallel or substantially parallel to the polarization orientation of the antenna 20. Thus, communications link quality between the second antenna A2 and the antenna 20 of the wireless client device would be poor. The first antenna A1, by not being selected for active communications, would not be available for communications to the antenna 20 of the wireless client device.

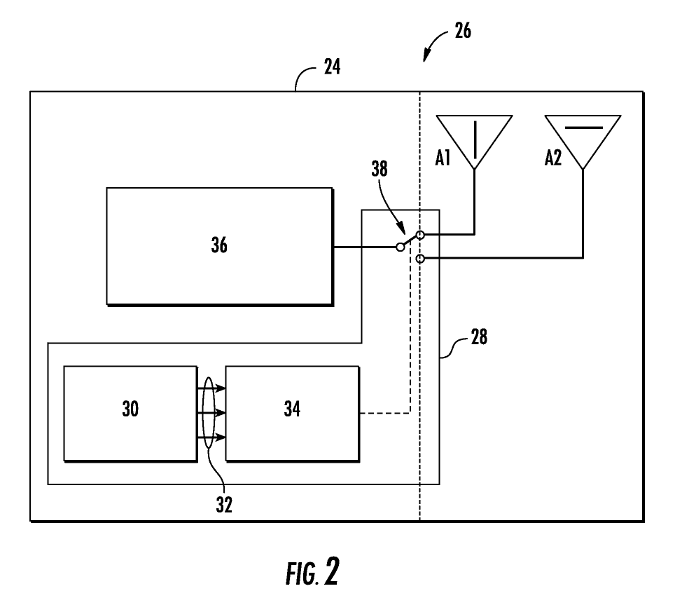

In this regard, to avoid relying on manual technician selection of the first antenna A1 or the second antenna A2 in the example of the RAU 26 in FIG. 1, an antenna selection arrangement can be provided. The antenna selection arrangement can be provided to select, including automatically, which antenna among two or more antenna arranged in different polarization orientations is to be used for active communications. In this manner, reliance on manual selection by a technician is not introduced to avoid the potential for incorrect selection based on orientation of installation of the RAU 26. FIG. 2 is a schematic diagram illustrating more detail of the RAU 26 in FIG. 1 including an antenna selection arrangement 28 to select among the first antenna A1 or the second antenna A2 for use in communications depending on the sensed orientation of the RAU 26.

As illustrated in FIG. 2, an antenna selection arrangement 28 can be provided in the RAU 26. In this embodiment, the antenna selection arrangement 28 includes an orientation sensor 30 configured to sense orientation of the RAU 26 with respect to ground 18. The orientation sensor 30 is configured to provide one or more orientation signals 32 indicative of the sensed orientation of the RAU 26. For example, the orientation sensor 30 could sense and distinguish between orientation 12(1) and orientation 12(2) of the RAU 26 as illustrated in FIG. 1. The orientation signals 32 are provided to an antenna selection device 34. The antenna selection device 34 receives the orientation signals 32 and processes the orientation signals 32 to determine which of the first antenna A1 or second antenna A2 should be coupled to a communications signal distributor, which may be transmitter 36 (which could also be a receiver or transceiver) for emission and reception of wireless communications signals. The communications signals distributor can also be a receiver for receiving communications signals or a transceiver that can receive and transmit communications signals.

As another example, the antenna selection device 34 may be configured to selectively couple the first antenna A1 to the transmitter 36 if the polarization orientation of the first antenna A1 is more closely aligned to the orientation of the RAU 26, as indicated by the orientation signals 32, than the polarization orientation of the second antenna A2 is aligned to the orientation indicated in the orientation signals 32. The antenna selection device 34 can also be configured to selectively couple the second antenna A2 to the transmitter 36 if the polarization orientation of the second antenna A2 is more closely aligned to the orientation of the RAU 26, indicated in the orientation signals 32, than the polarization orientation of the first antenna A1 is aligned to the orientation of the RAU 26.

The antenna selection device 34 may be implemented exclusively in circuits, or by use of a microprocessor executing software, as non-limiting examples. The antenna selection device 34 determines which of the first antenna A1 and second antenna A2 would provide the best or closest polarization orientation based on the sensed orientation of the RAU 26. The antenna selection device 34 is coupled to a switch 38 to select and close a circuit between either the transmitter 36 and the first antenna A1 or the transmitter 36 and the second antenna A2 based on the orientation of the RAU 26.

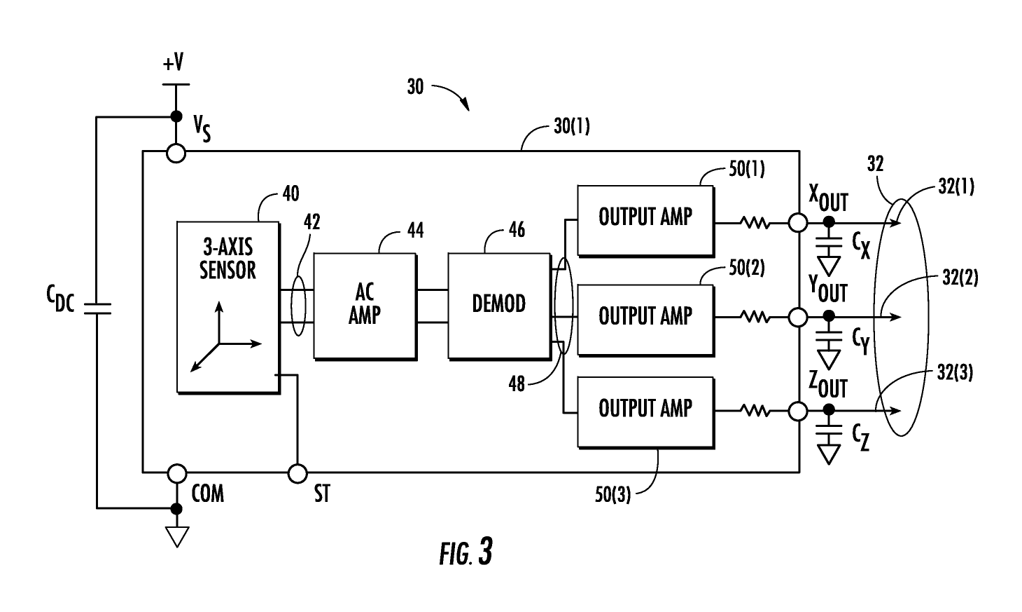

FIG. 3 is a schematic diagram of a three-dimensional accelerometer 30(1) that can be employed in the RAU 26 in FIGS. 1 and 2 as the orientation sensor 30 to detect orientation of the RAU 26 to control antenna selection. As illustrated in FIG. 3, the accelerometer 30(1) is configured to provide three orientation signals 32(1), 32(2), 32(3) comprising three dimensions in Cartesian coordinates—X, Y, and Z. The accelerometer 30(1) includes a 3-axis sensor 40 that detects the orientation of the RAU 26. The 3-axis sensor 40 provides axis signals 42 that are amplified by amplifier 44 and demodulated by demodulator 46 into separate coordinates signals 48. Each coordinate signal 48 is amplified by amplifiers 50(1), 50(2), 50(3) and provided as the orientation signals 32(1)-32(3). As a non-limiting example, the accelerometer 30(1) may be ADXL327 accelerometer produced by Analog Devices, Inc.

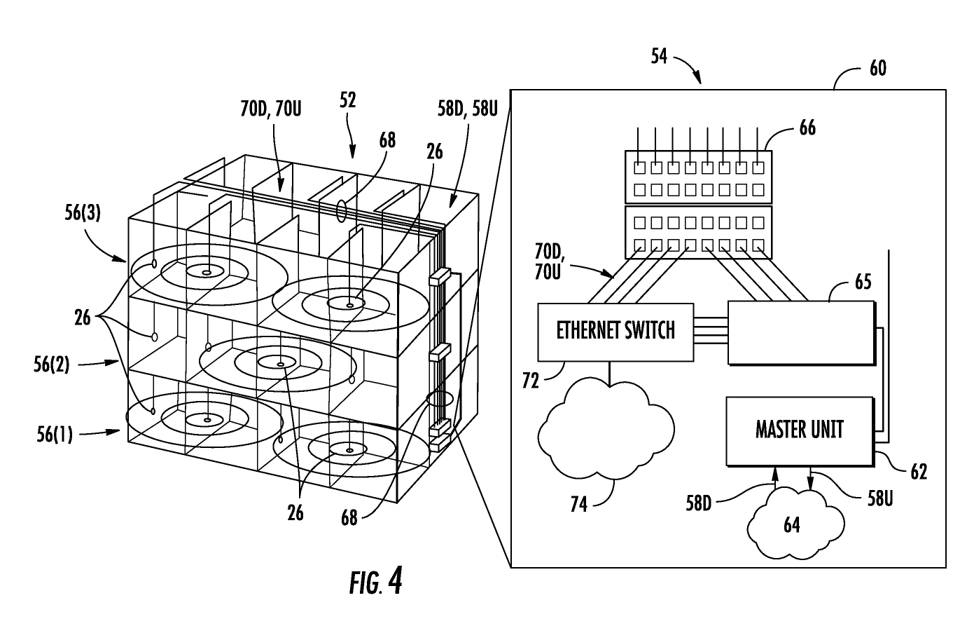

FIG. 4 is a schematic diagram of a building 52 in which a distributed antenna system 54 providing RAUs 26 employing an antenna selection can be provided. As illustrated therein, the building 52 may contain multiple floors 56(1), 56(2), 56(3). RAUs 26 may be distributed on each floor 56(1), 56(2), 56(3) and in multiple locations on each floor 56(1), 56(2), 56(3). The RAUs 26 receive distributed downlink communications signals 58D from head-end equipment (HEE) 60, and provide uplink communications signals 58U received from wireless client devices to the head-end equipment 60. The head-end-equipment 60 in this example may be comprised of a master unit 62 that is coupled to a network 64 to receive downlink communications signals 58D for distribution. The HEE 60 may provide the received downlink communications signals 58D to one or more slave controller units 65 which are coupled to panels 66 to be distributed over communication medium 68 to the RAUs 26. Similarly, the RAUs 26 can provide received uplink communications signals 58U over the communication medium 68 to be routed back to the slave controller unit 65 and master unit 62 to provide to the network 64.

With continuing reference to FIG. 4, the communications signals 58D, 58U supported by the master unit 62 and slave controller units 65 may be RF communication signals. The distributed antenna system 54 can also be configured to provide and support digital data signals 70D, 70U to the RAU 26. For example, an Ethernet switch 72 may be provided that is coupled to a digital data network 74 to distribute downlink digital data signals 70D to the RAUs 26 and to receive uplink digital data signals 70U from the RAUs 26. The digital data signals 70D, 70U may be transported over the same communication medium 68 to and from the RAUs 26, or over different communications medium to and from the RAUs 26.

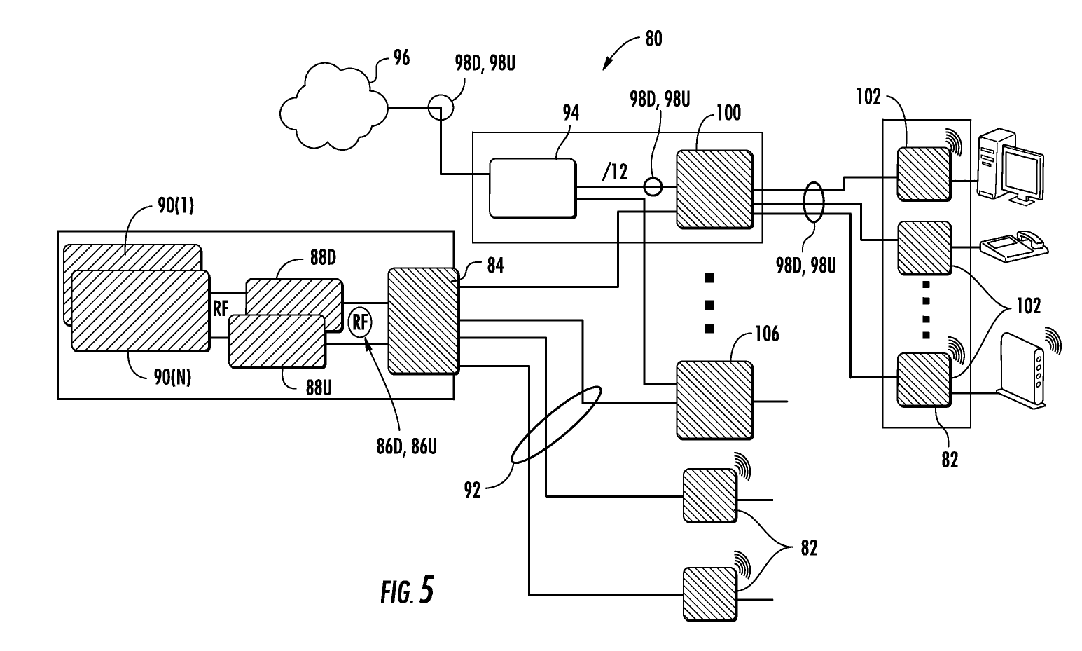

FIG. 5 is a schematic diagram of an exemplary electrical conductor medium-based DAS system 80 that includes RAUs 82 having antenna arrangements discussed herein, including the antenna arrangement 10 in FIGS. 1-3. The distributed antenna system 80 includes a master controller 84. The master controller 84 is configured to receive downlink electrical communications signals 86D through downlink interfaces 88D from one or more base stations 90(1)-90(N), wherein N can be any number. The master controller 84 is also configured to receive uplink electrical communications signals 86U from RAUs 82 to distribute to the one or more base stations 90(1)-90(N), via the uplink interfaces 88U. The master controller provides dedicated electrical conductor communication medium 92 (e.g., CAT 5,/5e/6/7 cable) to one or more RAUs 82. The electrical conductor communication medium 92 can carry the downlink electrical communications signals 86D to the RAUs 82 and carry return uplink electrical communications signals 86U to the one or more base stations 90(1)-90(N). Radio-frequency downlink electrical communications signals 86D and uplink electrical communications signals 86D may be carried over the same electrical conductor communication medium 92, such as at different frequencies to avoid interference. The master controller 84 may contain frequency conversion circuitry to frequency shift the downlink electrical communications signals 86D to a lower frequency for communication of the electrical conductor communication medium 92 and frequency shift the received uplink electrical communications signals 86U received from the RAUs 82 over the electrical conductor communication medium 92. Frequency shifting may be employed to provide for a lower bandwidth capable electrical conductor communication medium 92 to carry native higher frequency and higher bandwidth downlink and uplink electrical communications signals 86D, 86U.

A digital data switch 94 may also be provided in the distributed antenna system 80 for providing digital data signals to the RAUs 102 configured to support digital data services. These RAUs 102 may be configured with the antenna arrangements disclosed herein, including antenna arrangement 10 in FIGS. 1-3. The digital data switch 94 may be coupled to a network 96, such as the Internet. Downlink and uplink digital data signals 98D, 98U may be received by the digital data switch 94. The downlink digital data signals 98D can be distributed to the RAUs 82 through an intermediate controller 100. The digital data switch 94 can also receive uplink digital data signals 98U to be distributed back to the network 96. Some RAUs 106 in the distributed antenna system 80 may be configured to support both downlink digital data signals 98D from the digital data switch 94 and the downlink electrical communications signals 86D.

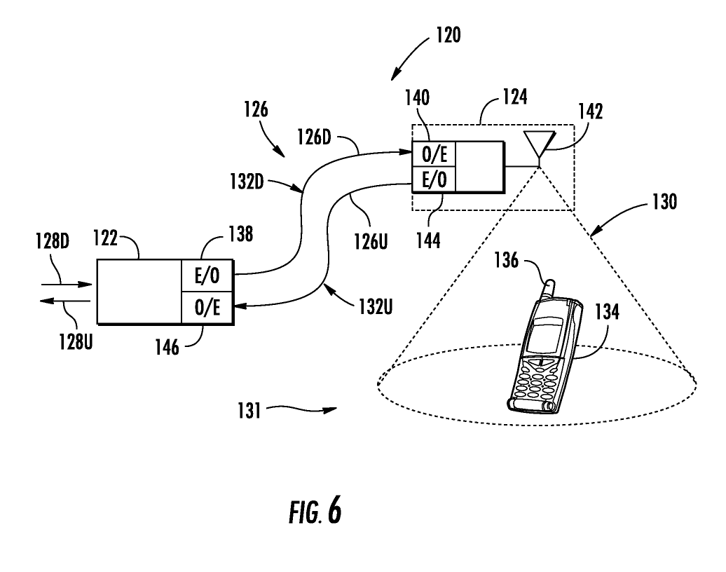

The DAS systems that can employ the antenna arrangements disclosed herein are not limited to distribution over electrical conductors (e.g., coaxial cable, twisted-pair conductors). Distribution mediums could also include wireless transmission and reception and/or optical fiber. In this regard, FIG. 6 is a schematic diagram of an embodiment of another DAS system that may employ an antenna arrangement employing an selection according to the examples provided herein, including the antenna arrangement 10 in FIGS. 1-3. In this embodiment, the system is an optical fiber-based distributed antenna system 120. The optical fiber-based DAS 120 is configured to create one or more antenna coverage areas for establishing communications with wireless client devices located in the RF range of the antenna coverage areas. The DAS 120 provides RF communication services (e.g., cellular services). In this embodiment, the DAS 120 includes head-end equipment (HEE) 122 such as a head-end unit (HEU), one or more remote antenna units (RAUs) 124, and an optical fiber 126 that optically couples the HEE 122 to the RAU 124.

The RAU 124 is a type of remote communications unit. In general, a remote communications unit can support either wireless communications, wired communications, or both. The RAU 124 can support wireless communications and may also support wired communications. The HEE 122 is configured to receive communications over downlink electrical RF signals 128D from a source or sources, such as a network or carrier as examples, and provide such communications to the RAU 124. The HEE 122 is also configured to return communications received from the RAU 124, via uplink electrical RF signals 128U, back to the source or sources. In this regard in this embodiment, the optical fiber 126 includes at least one downlink optical fiber 126D to carry signals communicated from the HEE 122 to the RAU 124 and at least one uplink optical fiber 126U to carry signals communicated from the RAU 124 back to the HEE 122.

One downlink optical fiber 126D and one uplink optical fiber 126U could be provided to support multiple channels each using wave-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are disclosed in U.S. patent application Ser. No. 12/892,424, any of which can be employed in any of the embodiments disclosed herein. Further, U.S. patent application Ser. No. 12/892,424 also discloses distributed digital data communications signals in a distributed antenna system which may also be distributed in the optical fiber-based distributed antenna system 120 either in conjunction with RF communications signals or not.

The system 120 has an antenna coverage area 130 that can be disposed about the RAU 124. The antenna coverage area 130 of the RAU 124 forms an RF coverage area 131. The HEE 122 is adapted to perform or to facilitate any one of a number of Radio-over-Fiber (RoF) applications, such as RF identification (RFID), wireless local-area network (WLAN) communication, or cellular phone service. Shown within the antenna coverage area 130 is a wireless client device 134 in the form of a mobile device as an example, which may be a cellular telephone as an example. The wireless client device 134 can be any device that is capable of receiving RF communications signals. The wireless client device 134 includes an antenna 136 (e.g., a wireless card) adapted to receive and/or send electromagnetic RF signals. As previously discussed above, it may be typical for the antenna 136 of the wireless client device 134 to be oriented perpendicular or substantially perpendicular to the ground during use such that the antenna 136 has a vertical polarization to the ground.

With continuing reference to FIG. 6, to communicate the electrical RF signals over the downlink optical fiber 126D to the RAU 124, to in turn be communicated to the wireless client device 134 in the antenna coverage area 130 formed by the RAU 124, the HEE 122 includes a radio interface in the form of an electrical-to-optical (E/O) converter 138. The E/O converter 138 converts the downlink electrical RF signals 128D to downlink optical RF signals 132D to be communicated over the downlink optical fiber 126D. The RAU 124 includes an optical-to-electrical (O/E) converter 140 to convert received downlink optical RF signals 132D back to electrical RF signals to be communicated wirelessly through a selected antenna 146 of the RAU 124 to wireless client devices 134 located in the antenna coverage area 130. The selected antenna 146 used in communication to the wireless client device 134 may be selected according to an antenna selection arrangement, including the antenna arrangement 10 disclosed herein that is included in the RAU 124.

Similarly, the selected antenna 142 is also configured to receive wireless RF communications from wireless client devices 134 in the antenna coverage area 130. In this regard, the selected antenna 146 receives wireless RF communications from wireless client devices 134 and communicates electrical RF signals representing the wireless RF communications to an E/O converter 144 in the RAU 124. The E/O converter 144 converts the electrical RF signals into uplink optical RF signals 132U to be communicated over the uplink optical fiber 126U. An O/E converter 146 provided in the HEE 122 converts the uplink optical RF signals 132U into uplink electrical RF signals, which can then be communicated as uplink electrical RF signals 128U back to a network or other source. The HEE 122 in this embodiment is not able to distinguish the location of the wireless client devices 134 in this embodiment. The wireless client device 134 could be in the range of any antenna coverage area 130 formed by an RAU 124.

In a typical cellular system, for example, a plurality of BTSs are deployed at a plurality of remote locations to provide wireless telephone coverage. Each BTS serves a corresponding cell and when a mobile wireless client device enters the cell, the BTS communicates with the mobile client device. Each BTS can include at least one radio transceiver for enabling communication with one or more subscriber units operating within the associated cell. As another example, wireless repeaters or bi-directional amplifiers could also be used to serve a corresponding cell in lieu of a BTS. Alternatively, radio input could be provided by a repeater, picocell, or femtocell as other examples.

The optical fiber 126D, 126U may have multiple nodes where distinct downlink and uplink optical fiber pairs can be connected to a given RAU 124. One downlink optical fiber 126D could be provided to support multiple channels each using wavelength-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are also disclosed in U.S. patent application Ser. No. 12/892,424, any of which can be employed in any of the embodiments disclosed herein.

The HEE 122 may be configured to support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

In another embodiment, an exemplary RAU 124 may be configured to support up to four (4) different radio bands/carriers (e.g. ATT, VZW, TMobile, Metro PCS: 700LTE/850/1900/2100). Radio band upgrades can be supported by adding remote expansion units over the same optical fiber (or upgrade to MIMO on any single band). The RAUs 124 and/or remote expansion units may be configured to provide external filter interface to mitigate potential strong interference at 700 MHz band (Public Safety, CH51,56); Single Antenna Port (N-type) provides DL output power per band (Low bands (<1 GHz): 14 dBm, High bands (>1 GHz): 15 dBm); and satisfies the UL System RF spec (UL Noise Figure: 12 dB, UL IIP3: −5 dBm, UL AGC: 25 dB range).

It may be desirable to provide both digital data services and RF communications services for wireless client devices in a distributed antenna system that employs an antenna selection arrangement. Examples of digital data services include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10G) Ethernet. Examples of digital data devices include, but are not limited to, wired and wireless servers, wireless access points (WAPs), gateways, desktop computers, hubs, switches, remote radio heads (RRHs), baseband units (BBUs), and femtocells. A separate digital data services network can be provided to provide digital data services to digital data devices.

In this regard, the optical fiber-based distributed antenna system 120 in FIG. 6 may be configured to support distribution of both radio frequency (RF) communication services and digital data services. The RF communication services and digital data services may be distributed over optical fiber to wireless client devices 134 through the RAUs 124. For example, digital data services include WLAN, WiMax, WiFi, Digital Subscriber Line (DSL), and LTE, etc. Digital data services can also be distributed over optical fiber separate from optical fiber 126D, 126U distributing RF communication services. Alternatively, digital data services can be distributed over common optical fiber 126D, 126U with RF communication services. For example, digital data services can be distributed over common optical fiber 126D, 126U with RF communication services at different wavelengths through wavelength-division multiplexing (WDM) and/or at different frequencies through frequency-division multiplexing (FDM). Power distributed in the optical fiber-based distributed antenna system to provide power to remote antenna units can also be accessed to provide power to digital data service components.

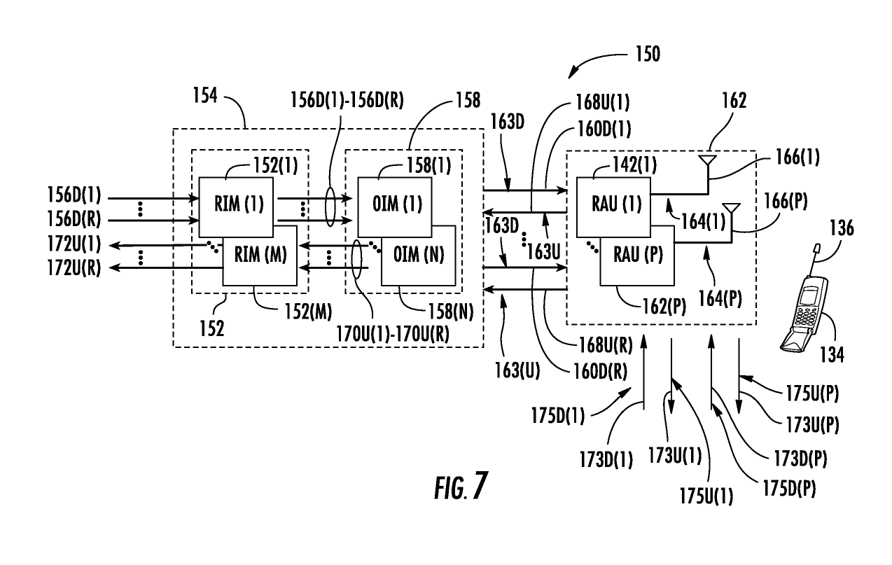

FIG. 7 is a schematic diagram of alternative head-end equipment (HEE) configured to distribute radio frequency (RF) communication services over optical fiber to RAUs that include an antenna selection arrangement, including the antenna arrangement 10 in FIGS. 1-3. For example, FIG. 7 is a schematic diagram of another exemplary distributed antenna system 150 that may be employed according to the embodiments disclosed herein to provide location services for client devices. In this embodiment, the distributed antenna system 150 is an optical fiber-based distributed antenna system. The distributed antenna system 150 includes optical fiber for distributing RF communication services. The distributed antenna system 150 in this embodiment is comprised of three (3) main components. One or more radio interfaces provided in the form of radio interface modules (RIMs) 152(1)-152(M) in this embodiment are provided in HEE 154 to receive and process downlink electrical RF communications signals 156D(1)-156D(R) prior to optical conversion into downlink optical RF communications signals. The RIMs 152(1)-152(M) provide both downlink and uplink interfaces. The processing of the downlink electrical RF communications signals 156D(1)-156D(R) can include any of the processing previously described above in the HEE 154. The notations “1-R” and “1-M” indicate that any number of the referenced component, 1-R and 1-M, respectively, may be provided. As will be described in more detail below, the HEE 154 is configured to accept a plurality of RIMs 152(1)-152(M) as modular components that can easily be installed and removed or replaced in the HEE 154. In one embodiment, the HEE 154 is configured to support up to eight (8) RIMs 152(1)-152(M).

Each RIM 152(1)-152(M) can be designed to support a particular type of radio source or range of radio sources (i.e., frequencies) to provide flexibility in configuring the HEE 154 and the distributed antenna system 150 to support the desired radio sources. For example, one RIM 152 may be configured to support the Personal Communication Services (PCS) radio band. Another RIM 152 may be configured to support the 700 MHz radio band. In this example, by inclusion of these RIMs 152, the HEE 154 would be configured to support and distribute RF communications signals on both PCS and LTE 700 radio bands. RIMs 152 may be provided in the HEE 154 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). RIMs 152 may be provided in the HEE 154 that support any wireless technologies desired, including but not limited to Code Division Multiple Access (CDMA), CDMA200, 1xRTT, Evolution—Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

RIMs 152 may be provided in the HEE 154 that support any frequencies desired, including but not limited to US FCC, Industry Canada, and EU R & TTE frequencies.

The downlink electrical RF communications signals 156D(1)-156D(R) are provided to a plurality of optical interfaces provided in the form of optical interface modules (OIMs) 158(1)-158(N) in this embodiment to convert the downlink electrical RF communications signals 156D(1)-156D(R) into downlink optical RF communications signals 160D(1)-160D(N). The notation “1-N” indicates that any number of the referenced component 1-N may be provided. The OIMs 158 may be configured to provide one or more optical interface components (OICs) that contain O/E and E/O converters, as will be described in more detail below. The OIMs 158 support the radio bands that can be provided by the RIMs 152, including the examples previously described above. Thus, in this embodiment, the OIMs 158 may support a radio band range from 400 MHz to 2700 MHz, as an example, so providing different types or models of OIMs 158 for narrower radio bands to support possibilities for different radio band-supported RIMs 152 provided in the HEE 154 is not required. Further, as an example, the OIMs 158 may be optimized for sub-bands within the 400 MHz to 2700 MHz frequency range, such as 400-700 MHz, 700 MHz-1 GHz, 1 GHz-1.6 GHz, and 1.6 GHz-2.7 GHz, as examples.

The OIMs 158(1)-158(N) each include E/O converters to convert the downlink electrical RF communications signals 156D(1)-156D(R) to downlink optical RF communications signals 160D(1)-160D(N). The downlink optical RF communications signals 160D(1)-160D(N) are communicated over downlink optical fiber(s) 163D(1) to a plurality of RAUs 142(1)-142(P). O/E converters provided in the RAUs 142(1)-142(P) convert the downlink optical RF communications signals 160D(1)-160D(N) back into downlink electrical RF communications signals 156D(1)-156D(R), which are provided over downlinks 164D(1)-164D(N) coupled to antennas 166(1)-166(P) in the RAUs 142(1)-142(P) to client devices in the reception range of the antennas 166(1)-166(P).

E/O converters are also provided in the RAUs 142(1)-142(P) to convert uplink electrical RF communications signals received from client devices through the antennas 166(1)-166(P) into uplink optical RF communications signals 168U(1)-168U(N) to be communicated over uplink optical fibers 168U(1)-168U(N) to the OIMs 158(1)-158(N). The OIMs 158(1)-158(N) include O/E converters that convert the uplink optical RF communications signals 168U(1)-168U(N) into uplink electrical RF communications signals 170U(1)-170U(R) that are processed by the RIMs 152(1)-152(M)and provided as uplink electrical RF communications signals 172U(1)-172U(R).

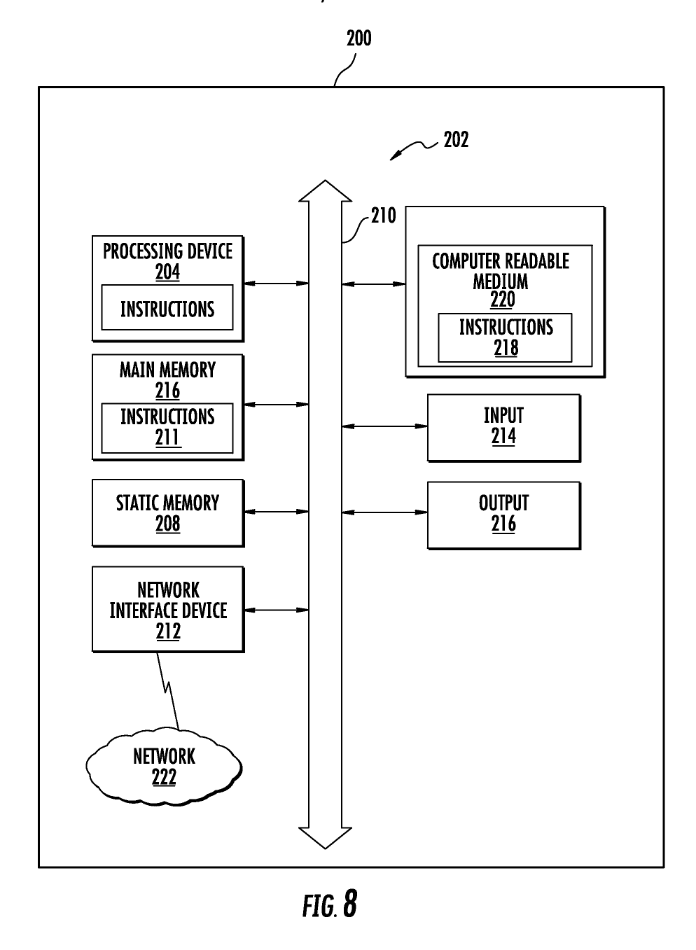

The antenna apparatuses and RAUs that include antenna selection based on orientation disclosed herein can include a computer system. In this regard, FIG. 8 is a schematic diagram representation of additional detail regarding the exemplary antenna selection device 34 in the exemplary form of an exemplary computer system 200 adapted to execute instructions from an exemplary computer-readable medium to perform power management functions. In this regard, the antenna selection device 34 may comprise the computer system 200 within which a set of instructions for causing the antenna selection device 34 to perform any one or more of the methodologies discussed herein may be executed. The antenna selection device 34 may be connected (e.g., networked) to other machines in a LAN, an intranet, an extranet, or the Internet. The antenna selection device 34 may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The antenna selection device 34 may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer.

The exemplary computer system 200 of the antenna selection device 34 in this embodiment includes a processing device 204, a main memory 216 (e.g., read-only memory (ROM), flash memory, dynamic random access memory (DRAM) such as synchronous DRAM (SDRAM), etc.), and a static memory 208 (e.g., flash memory, static random access memory (SRAM), etc.), which may communicate with each other via the data bus 210. Alternatively, the processing device 204 may be connected to the main memory 216 and/or static memory 208 directly or via some other connectivity means. The processing device 204 may be a controller, and the main memory 216 or static memory 208 may be any type of memory, each of which can be included in the HEE 124.

The processing device 204 represents one or more general-purpose processing devices such as a microprocessor, central processing unit, or the like. More particularly, the processing device 204 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 204 is configured to execute processing logic in instructions 211/218? for performing the operations and steps discussed herein.

The computer system 200 may further include a network interface device 212, and an input 214 to receive input and selections to be communicated to the computer system 200 when executing instructions. The computer system 200 also may include an output 216, such as a video display unit, an alphanumeric input device (e.g., a keyboard), and/or a cursor control device (e.g., a mouse).

The computer system 200 may include a data storage device that includes instructions 218 stored in a computer-readable medium 220. The instructions 218 may also reside, completely or at least partially, within the main memory 216 and/or within the processing device 204 during execution thereof by the computer system 200, the main memory 216 and the processing device 204 also constituting computer-readable medium. The instructions 211 may further be transmitted or received over a network 222 via the network interface device 212.

While the computer-readable medium 220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer).

Unless specifically stated otherwise as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both The components of the distributed antenna systems described herein may be employed in any circuit, hardware component, integrated circuit (IC), or IC chip, as examples. Memory disclosed herein may be any type and size of memory and may be configured to store any type of information desired.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

As used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like.

The antenna arrangements disclosed herein may include any type of antenna desired, including but not limited to dipole, monopole, and slot antennas. The DAS systems that employ the antenna arrangements disclosed herein could include any type or number of communications mediums, including but not limited to electrical conductors, optical fiber, and air (i.e., wireless transmission). The DAS systems may distribute and the antenna arrangements disclosed herein may be configured to transmit and receive any type of communications signals, including but not limited to RF communications signals and digital data communications signals, examples of which are described in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Multiplexing, such as WDM and/or FDM, may be employed in any of the distributed antenna systems described herein, such as according to the examples provided in U.S. patent application Ser. No. 12/892,424.

It is intended that the embodiments cover the modifications and variations of the embodiments provided they come within the scope of the appended claims and their equivalents. Although specific terms are employed herein, they are used in a generic and descriptive sense only and not for purposes of limitation.

1. An antenna arrangement for distributing communications signals in a distributed antenna system, comprising:
a first antenna arranged to have a first polarization orientation;
a second antenna arranged to have a second polarization orientation different from the first polarization orientation of the first antenna;
an orientation sensor configured to sense orientation with respect to ground and provide an at least one orientation signal indicative of the sensed orientation; and
an antenna selection device configured to receive the at least one orientation signal and selectively couple one of the first antenna and the second antenna to a communications signal distributor for receiving and emitting communications signals to a wireless client device.

2. The antenna arrangement of claim 1, wherein the antenna selection device is further configured to selectively couple one of the first antenna and the second antenna to the communications signal distributor based on the orientation indicated in the at least one orientation signal.

3. The antenna arrangement of claim 2, wherein the antenna selection device is further configured to selectively couple the first antenna to the communications signal distributor if the first polarization orientation is more closely aligned to the orientation indicated in the at least one orientation signal than the second polarization orientation is aligned to the orientation indicated in the at least one orientation signal.

4. The antenna arrangement of claim 3, wherein the antenna selection device is further configured to selectively couple the second antenna to the communications signal distributor if the second polarization orientation is more closely aligned to the orientation indicated in the at least one orientation signal than the first polarization orientation is aligned to the orientation indicated in the at least one orientation signal.

5. The antenna arrangement of claim 1, wherein the orientation sensor is comprised of a three-dimensional accelerometer.

6. The antenna arrangement of claim 1, wherein the at least one orientation signal is comprised of a first orientation signal representing orientation in a first dimension, a second orientation signal representing orientation in a second dimension, and a third orientation signal representing orientation in a third dimension.

7. The antenna arrangement of claim 6, wherein the first orientation signal, the second orientation signal, and the third orientation signal represent a Cartesian coordinate system.

8. The antenna arrangement of claim 1, further comprising a switch coupled to the first antenna and the second antenna, the antenna selection device configured to select the switch to selectively couple one of the first antenna and the second antenna to the communications signal distributor.

9. The antenna arrangement of claim 1, wherein the first polarization orientation is perpendicular to the second polarization orientation.

10. The antenna arrangement of claim 9, wherein the first antenna is comprised of a first patch antenna, and the second antenna is comprised of a second patch antenna, the first patch antenna being disposed in a first plane and the second patch antenna being disposed in a second plane perpendicular to the first plane.

11. A method for antenna selection of an antenna for emitting communications signals in a distributed antenna system, comprising:
receiving communications signals from a communications signal distributor;
receiving at least one orientation signal indicative of a sensed orientation from an orientation sensor configured to sense orientation with respect to ground; and
selectively coupling one of a first antenna arranged to have a first polarization orientation and a second antenna arranged to have a second polarization orientation different from the first polarization orientation of the first antenna, to the communications signal distributor for receiving and emitting the communications signals to a wireless client device.

12. The method of claim 11, wherein the selectively coupling further comprises selectively coupling one of the first antenna and the second antenna to the communications signal distributor based on the orientation indicated in the at least one orientation signal.

13. The method of claim 12, wherein the selectively coupling further comprises selectively coupling the first antenna to the communications signal distributor if the first polarization orientation is more closely aligned to the orientation indicated in the at least one orientation signal than the second polarization orientation is aligned to the orientation indicated in the at least one orientation signal.

14. The method of claim 13, wherein the selectively coupling further comprises selectively coupling the second antenna to the communications signal distributor if the second polarization orientation is more closely aligned to the orientation indicated in the at least one orientation signal than the first polarization orientation is aligned to the orientation indicated in the at least one orientation signal.

15. The method of claim 11, wherein receiving the at least one orientation signal comprises:
receiving a first orientation signal representing orientation in a first dimension;
receiving a second orientation signal representing orientation in a second dimension; and
receiving a third orientation signal representing orientation in a third dimension.

16. The method of claim 11, wherein the selectively coupling further comprises selecting a switch to selectively couple one of the first antenna and the second antenna to the communications signal distributor.

17. A remote antenna unit (RAU) for distributing communications signals in a distributed antenna system, comprising:
a downlink communications signal distributor configured to receive downlink communications signals from head end equipment and distribute the downlink communications signals to wireless client devices;
at least one antenna arrangement, comprising:
a first antenna arranged to have a first polarization orientation;
a second antenna arranged to have a second polarization orientation different from the first polarization orientation of the first antenna;
an orientation sensor configured to sense orientation with respect to ground and provide an at least one orientation signal indicative of the sensed orientation; and
an antenna selection device configured to receive the at least one orientation signal and selectively couple one of the first antenna and the second antenna to a downlink communications signal distributor for receiving and emitting the downlink communications signals received from the downlink communications signal distributor.

18. The RAU of claim 17, wherein the antenna selection device is further configured to selectively couple one of the first antenna and the second antenna to the downlink communications signal distributor based on the orientation indicated in the at least one orientation signal.

19. The RAU of claim 18, wherein the antenna selection device is further configured to selectively couple the second antenna to the downlink communications signal distributor if the second polarization orientation is more closely aligned to the orientation indicated in the at least one orientation signal than the first polarization orientation is aligned to the orientation indicated in the at least one orientation signal.

20. The RAU of claim 17, further comprising an uplink communications signal distributor configured to receive and distribute to the head end equipment, uplink communications signals from wireless client devices from the selectively coupled one of the first antenna and the second antenna, wherein the antenna selection device is further configured to selectively couple one of the first antenna and the second antenna to the uplink communications signal distributor based on the orientation indicated in the at least one orientation signal.

21. The RAU of claim 20, wherein the antenna selection device is further configured to selectively couple the second antenna to the uplink communications signal distributor if the second polarization orientation is more closely aligned to the orientation indicated in the at least one orientation signal than the first polarization orientation is aligned to the orientation indicated in the at least one orientation signal.

22-27. (canceled)
